(19) United States
(12) Patent Application Publication
(10) Pub. No.: US 2006/0047703 A1
(43) Pub. Date: Mar. 2, 2006

(54) Keyword relatedness bidding system

(76) Inventors: Jason Strober, Los Altos, CA (US); Mark Benning, Menlo Park, CA (US); Matthew Patterson, Emerald Hills, CA (US)

Correspondence Address: PERKINS COIE LLP, P.O. BOX 2168, MENLO PARK, CA, 94026, US

(21) Appl. No.: 11/201,564

(22) Filed: Aug. 10, 2005

Related U.S. Application Data
(60) Provisional application No. 60/605,731, filed on Aug. 30, 2004.

(51) Int. Cl. G06F 17/00

(52) U.S. Cl. 707/104.1

(57) ABSTRACT

A computer-implemented-method for adjusting keyword bids includes aggregating a plurality of keywords into a pool and performing a statistical analysis of the pool to determine a return-on-investment factor. Each keyword is then evaluated in view of the return-on-investment factor and use of an individual keyword is paused or a bid price of the individual keyword is maintained or adjusted or the individual keyword is deleted—all of which is based on the return-on-investment factor.

### FIELD OF THE INVENTION

The present invention relates to Internet advertising and more particularly to keyword bids.

### BACKGROUND OF THE INVENTION

Internet advertising is rapidly gaining acceptance as a viable and effective medium for growing a business. The key to a successful Internet advertising campaign is to reach those customers that have a genuine interest to potentially patronize the business behind the advertisement. Otherwise, random banner advertisements on a webpage are routinely ignored because they do not reach the right audience.

One prior art method to correct this deficiency is to display advertisements based on keywords in a search query. To further illustrate, FIG. 1 is a prior art block diagram 10 illustrating a keyword advertising process. Included in block diagram 10 are a screenshot 20 of a web search results page and a screenshot 30 of a page accessible by clicking an advertisement 40 on screenshot 20. Screenshot 20 includes a searchbox 50, a search button 60, search results 70 and advertisement 40 and 80. “Sony Vaio” was the subject of the search in screenshot 20 and advertisements 40 and 80 are displayed because they have keywords associated with them that include “Sony” or “Vaio” or perhaps both. If a user clicks on advertisement 40, they are brought to screenshot 30 and are offered a chance to win a Sony Vaio notebook computer.

Typically, a business is charged every time an advertisement is clicked. Obviously, more clicks will occur if the correct keywords are selected. To facilitate the keyword selection process, businesses will sometimes employ keyword bidding services. Keyword bidding services place a bid on a keyword. Generally, the higher the bid, the more likely it will be that the keyword will cause an associated advertisement to appear on a search results page. These services typically make money, sometimes referred to as a “bounty”, when certain actions are completed. For example, this can take the form of a purchase resulting from an advertisement click-through or in the case of screenshot 30, a user completing the form to win a Sony Vaio notebook computer. Typically the keyword bidding services pay for the click-through charge. That is, a search is executed, advertisements are displayed based on keywords in the search query and the keyword bidding service is charged if the advertisement is clicked. As a result, it is extremely important to select the correct keywords and the correct bid price.

However, the process of deciding what keywords to keep is not always straightforward. FIG. 2 is a prior art diagram illustrating a decision process 90 to eliminate non-performing keywords. In general, if a keyword is generating lots of profit, as indicated by region 100, then the keyword should be kept. If a keyword is making minimal profit, as indicated by region 110, it is generally safe to discard that keyword. Keywords that fall in region 120 are difficult to analyze. They are making some money and perhaps they will continue to make money. Conversely, perhaps they will soon fall into region 110. Decision process 90 is further compounded in that data needs to be accumulated before a decision can be made. This is problematic as all keywords will initially fall into region 110 until they hopefully become profitable. The key is to be able to quickly identify those non-profitable keywords that fall in region 110 and to take appropriate actions to keywords that are in region 120 to make them more profitable. Another shortcoming of decision process 90 is that it is non-automated. Furthermore, it is possible to bid to high on a keyword as a high volume of click-throughs does not always translate to sustained profits.

As a result of the above situation, there is a need for methods and systems to automatically measure the effectiveness of keywords to enhance profitability.

### SUMMARY OF THE INVENTION

The present invention is described and illustrated in conjunction with systems, apparatuses and methods of varying scope. In addition to the aspects of the present invention described in this summary, further aspects of the invention will become apparent by reference to the drawings and by reading the detailed description that follows.

A computer-implemented-method for adjusting keyword bids, in accordance with an embodiment of the present invention, includes aggregating a plurality of keywords into a pool and performing a statistical analysis of the pool to determine a return-on-investment factor. Each keyword is then evaluated in view of the return-on-investment factor and use of an individual keyword is paused or a bid price of the individual keyword is maintained or adjusted or the individual keyword is deleted—all of which is based on the return-on-investment factor.

A computer-implemented-method for adjusting keyword bids, in accordance with another embodiment of the present invention, includes aggregating a plurality of keywords into a pool and performing a least-squares regression and a confidence interval on the pool to determine a return-on-investment factor. Each keyword is then evaluated in view of the return-on-investment factor and use of an individual keyword is paused or a bid price of the individual keyword is maintained or adjusted or the individual keyword is deleted—all of which is based on the return-on-investment factor.

A system for adjusting keyword bids, in accordance with another embodiment of the present invention, includes one or more report parsers for extracting one or more keyword statistical reports and a database for storing the one or more keyword statistical reports. Also included is a bid engine for analyzing the one or more keyword statistical reports and adjusting the keyword bid.

A computer-implemented method for enhancing profitability of a keyword bid, in accordance with a final embodiment of the present invention, includes determining if a volume of the keyword is below about a first threshold and determining if the keyword bid is below about a second threshold. The keyword bid is then adjusted based on the profitability of the keyword bid, the volume of the keyword in relation to the first threshold and the keyword bid in relation to the second threshold

Embodiments of the invention presented are exemplary and illustrative in nature, rather than restrictive. The scope of the invention is determined by the appended claims.

### BRIEF DESCRIPTION OF THE DRAWINGS

FIG. 1 is a prior art block diagram illustrating a keyword advertising process;

FIG. 2 is a prior art diagram illustrating a decision process to eliminate non-performing keywords;

FIG. 3A is a chart of cost vs. profit; in accordance with an embodiment of the present invention;

FIG. 3B is a chart of cost vs. profit fitted with a least squares regression line, in accordance with an embodiment of the present invention;

FIG. 3C is a chart of cost vs. profit fitted with a least squares regression line and a one-sided confidence interval, in accordance with an embodiment of the present invention;

FIG. 4 is an exemplary chart of bid price vs. profit, in accordance with an embodiment of the present invention;

FIGS. 5A-5D are charts illustrating various bid price vs. profit scenarios, in accordance with embodiments of the present invention;

FIG. 6 illustrates an exemplary keyword relatedness bidding system, in accordance with an embodiment of the present invention;

FIG. 7 is a block diagram of an embodiment of a network, such as the Internet;

FIG. 8 is a block diagram of an embodiment of a computer that can be used as a client computer system or a server computer system or as a web server system; and

FIG. 9 is a flowchart illustrating a method for adjusting a keyword bid, in accordance with an embodiment of the present invention.

### DETAILED DESCRIPTION OF THE INVENTION

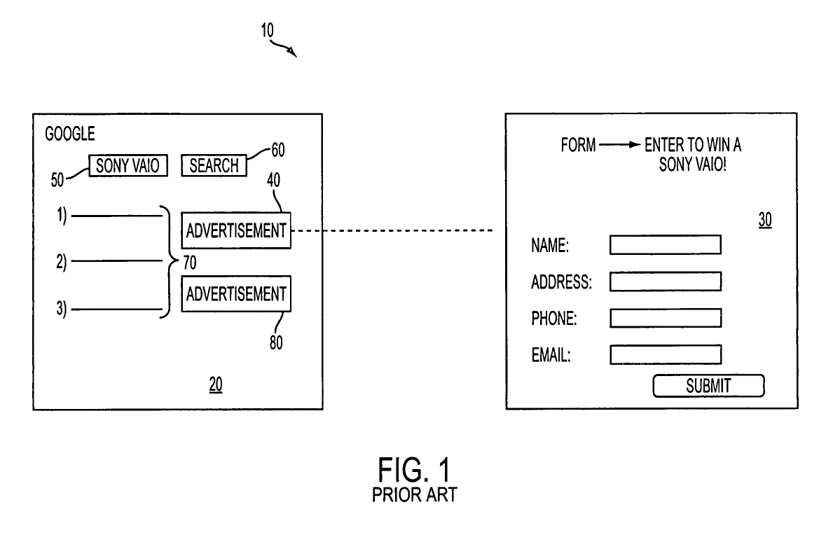

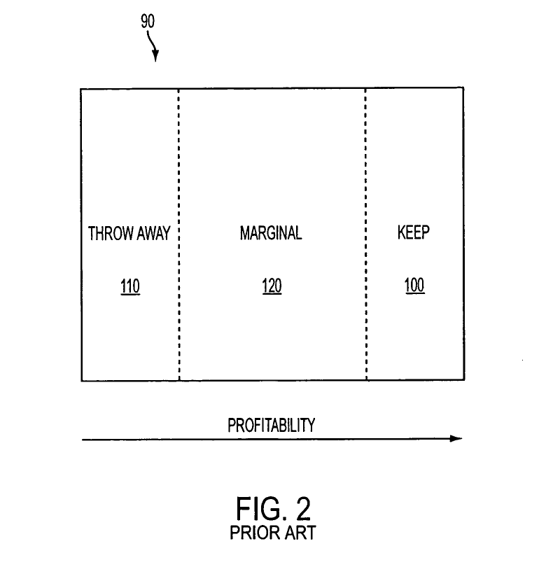

FIGS. 1-2 were previously discussed with reference to the prior art. The present invention contemplates a variety of methods and systems for providing statistical analysis of a keyword's profitability. By grouping a pool of similar terms and charting their profitability, a least means square fit can be performed and then a one-sided confidence interval can be calculated. Any words that fall outside the confidence interval should be dropped as they are not performing. Aggregation pooling is provided by any one of a variety of statistical methods such as pattern recognition. Other forms of statistical analysis for evaluating the aggregated pools are also contemplated. Additionally, further analysis can be performed to evaluate pools as a whole in addition to keywords within the pools. In another aspect of the present invention, bid prices are automatically adjusted to achieve an optimal bidding price. The adjustment is based on historical performance of the keyword and is designed to keep the keyword performing at its maximum profitability output.

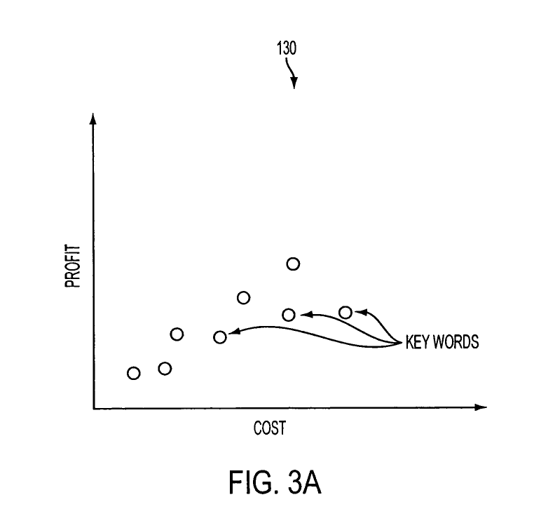

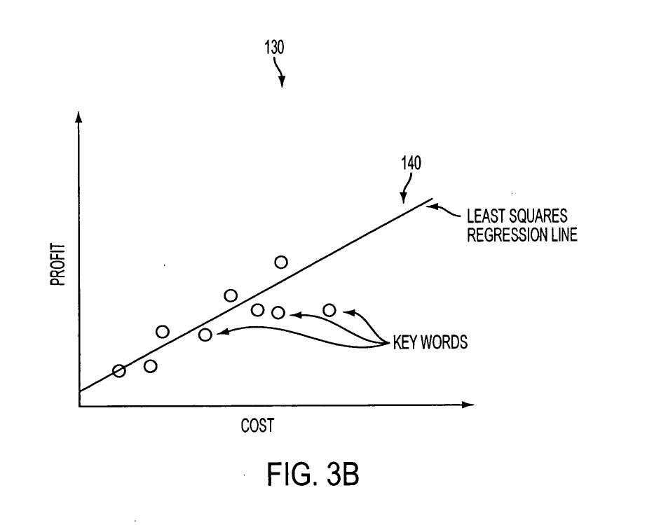

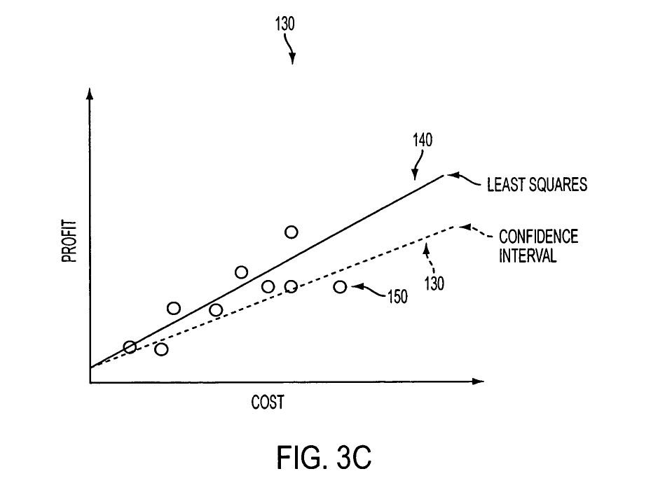

FIGS. 3A-3B illustrate an embodiment of the present invention for statistically determining when to drop a keyword. FIG. 3A is a chart 130 of cost vs. profit; in accordance with an embodiment of the present invention. The historical, cumulative cost (that is, the charge incurred for a user clicking on an advertisement resulting from a search query) is graphed as a function of the total profit for that keyword (that is, the total dollar amount of bounties that resulted from the user accessing the advertisement by buying product or performing some other defined action).

FIG. 3B is a chart 130 of cost vs. profit fitted with a least squares regression line 140 and FIG. 3C is a chart 130 of cost vs. profit fitted with a least squares regression line and a one-sided confidence interval, both in accordance with embodiments of the present invention. Least squares regression and confidence intervals are both well-known statistical techniques. As such, an explanation on how to perform least squares regression and confidence intervals will not be presented so as to not to obscure aspects of the present invention. Additionally, one skilled in the art that will recognize that other similar statistical techniques can be employed without departing from the true scope and spirit of the present invention.

After the least squares regression fit 140 is performed, a one-sided confidence interval 130 is calculated. Any keywords that fall below confidence interval 130, such as keyword 150, is considered to be non-performing and should be removed as a keyword. In a preferred embodiment of the present invention, the confidence interval is a 95% confidence interval.

Once non-performing keywords are removed, it is desirable to optimally price the bid amount associated with a keyword. That is, sometimes a word may be showing profitability and it would be prudent to increase the bid price. This ought to cause an associated advertisement to appear more frequently, thus increasing the number of click-throughs and potentially the number of bounties. However, if the bid price is increased too much, the profitability may fall as well because the keyword is only capable of generating so many bounties.

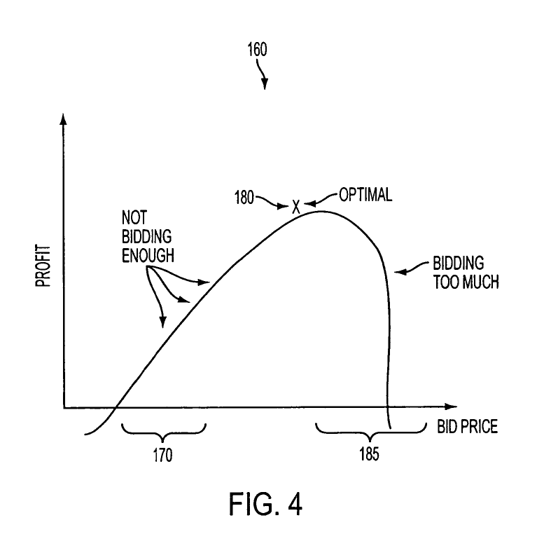

This process is further illustrated with reference to FIG. 4 which is an exemplary chart 160 of bid price vs. profit, in accordance with an embodiment of the present invention. At a lower end 170 of the bid price scale, there is still room to increase the bid price as previous increases resulted in increased profitability until point 180 is reached. Further price increases in the bid price, such as into region 185, results in decreased profitability and the bid price should be scaled back.

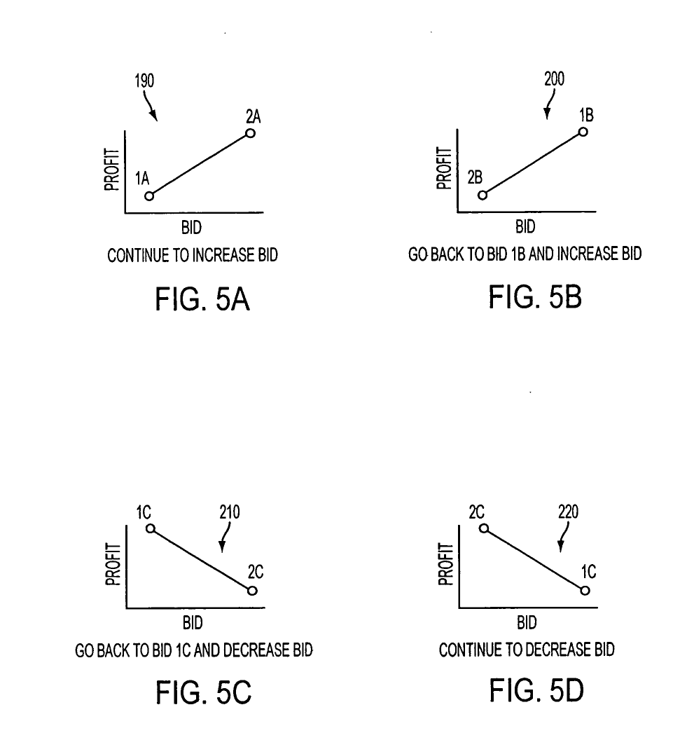

To further refine the methodology of how to adjust the bid price will now be discussed with reference to FIGS. 5A-5D which are charts (190, 200, 210 and 220). illustrating various bid price vs. profit scenarios, in accordance with embodiments of the present invention. Chart 190 illustrates the results of increasing a bid from point 1A to point 2A. In this particular instance, profitability increased with the increase in bid price. Therefore, it is probably warranted to perform another increase on the bid price as it would probably increase profitability.

Referring to chart 200, profits decrease when the bid price was adjusted downward from point 1B to point 2B. In this example, it would perhaps make sense to go back to bid 1B and increase the bid price. In chart 210, profit decreased when the bid price was increased from 1C to 2C. For chart 210, it would perhaps be logical to go back to bid 1C. Finally, chart 220 indicates an increase in profit when the bid price was lowered from 1C to point 2C. Therefore, the bid price ought to be decreased further.

The following table I provides an exemplary implementation of the heuristics for adjusting the bid price:

TABLE I

| | | | BID |
|---|---|---|---|
| PROFITABLE? | VOLUME < $10 | BID SIZE < $0.10 | INCREMENT/AMOUNT |
| YES | YES | YES | +$0.05 |
| YES | YES | NO | +50% |
| YES | NO | YES | +$0.02 |
| YES | NO | NO | +10% |
| NO | YES | YES | −$0.05 or $0.05 |
| NO | YES | NO | Go to previous profitable |
| | | | bid if one existed or |
| | | | remove |
| NO | NO | NO | −50% |

Regarding the “profitable?” column, if a keyword is profitable, only small adjustments ought to be taken. In contrast, if a keyword is very unprofitable, the bid should be reduced by a nickel. If a word is mildly profitable or unprofitable (region 120 of FIG. 2, for example), the techniques illustrated in FIGS. 3A-3D are employed to determine whether to keep the word.

In reference to the “volume” column, if a word has a lot of volume as measured by total cost, adjustments ought to be incremental as small moves may have large cost implications. If a keyword has very low volume, for example less than $1, then the tools of FIGS. 3A-3D can be employed to determine whether to keep that keyword. Finally, regarding “bidsize”, if a word has a low bid, even small absolute changes can perhaps have large percentage changes.

In some embodiments, it is preferable to temporarily retire a poor performing keyword as sometimes bounty data may not necessarily show up right away. For example, a user may perform a search query and click on a resulting advertisement. Perhaps at that point in time the user needs to attend to other tasks but comes back to the website, related to the advertisement, and purchases a product or performs some other function. As a result, that keyword provided delayed results. In a preferred embodiment, a 30-day cookie is employed to keep track of this sort of transaction.

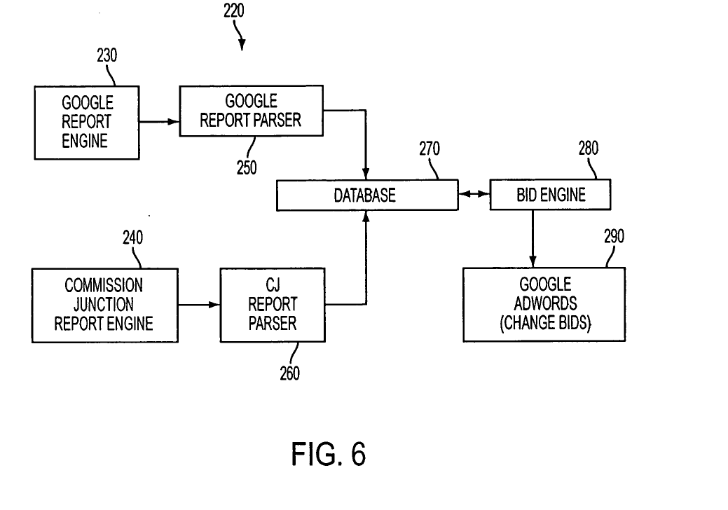

To implement the present invention, the system as described in FIG. 6 can perhaps be utilized. FIG. 6 illustrates an exemplary keyword relatedness bidding system 220, in accordance with an embodiment of the present invention. Included in system 220 are report engines 230 and 240, report parsers 250 and 260, database 270, bid engine 280 and ad words module 290. Report engines 230 and 240 generate reports on keyword performance. Parsers 250 and 260 extracts the reports, massages them into a usable format and stores them in database 270. Bid engine 280 then performs analysis, such as the analysis described in FIGS. 3A-5, to adjust the bid prices and perhaps retire non-profitable keywords. Once the analysis is completed, the necessary changes are affected at ad words module 290.

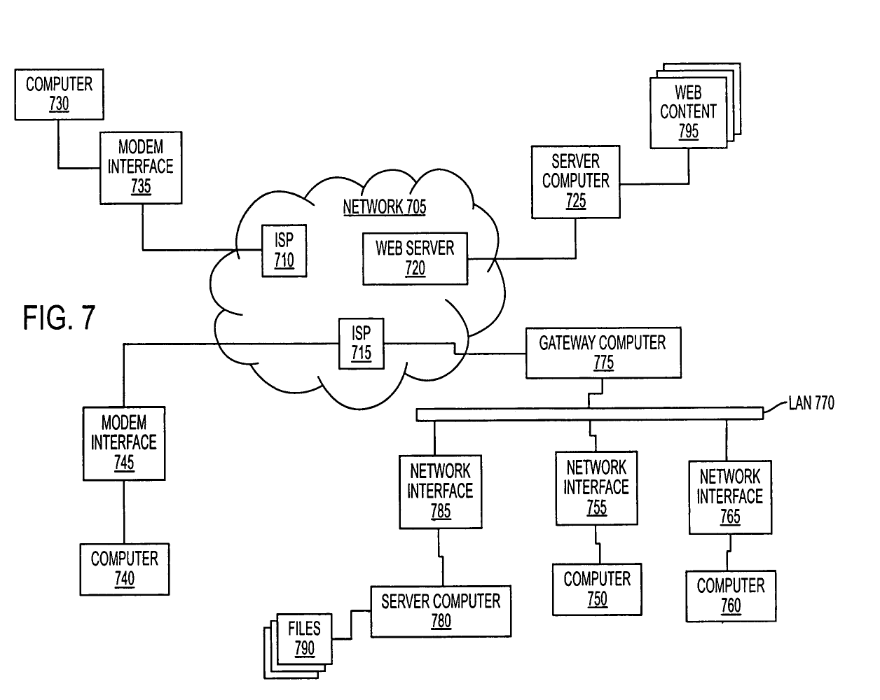

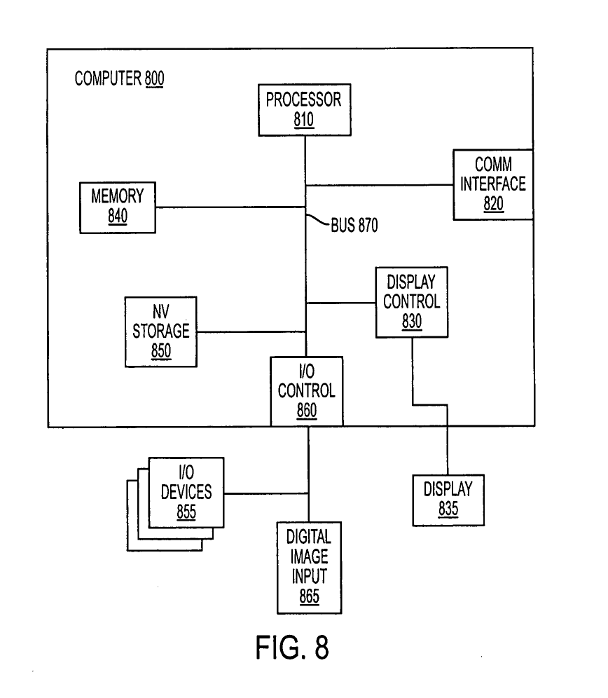

The following description of FIGS. 7-8 is intended to provide an overview of computer hardware and other operating components suitable for performing the methods of the invention described above, but is not intended to limit the applicable environments. Similarly, the computer hardware and other operating components may be suitable as part of the apparatuses of the invention described above. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 7 is a block diagram of an embodiment of a network 705, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (web). The physical connections of the Internet and the protocols and communication procedures of the Internet are well known to those of skill in the art.

Access to the Internet 705 is typically provided by Internet service providers (ISP), such as the ISPs 710 and 715. Users on client systems, such as client computer systems 730, 740, 750, and 760 obtain access to the Internet through the Internet service providers, such as ISPs 710 and 715. Access to the Internet allows users of the client computer systems to exchange information, receive and send e-mails, and view documents, such as documents which have been prepared in the HTML format. These documents are often provided by web servers, such as web server 720 which is considered to be “on” the Internet. Often these web servers are provided by the ISPs, such as ISP 710, although a computer system can be set up and connected to the Internet without that system also being an ISP.

The web server 720 is typically at least one computer system which operates as a server computer system and is configured to operate with the protocols of the World Wide Web and is coupled to the Internet. Optionally, the web server 720 can be part of an ISP which provides access to the Internet for client systems. The web server 720 is shown coupled to the server computer system 725 which itself is coupled to web content 795, which can be considered a form of a media database. While two computer systems 720 and 725 are shown in FIG. 7, the web server system 720 and the server computer system 725 can be one computer system having different software components providing the web server functionality and the server functionality provided by the server computer system 725 which will be described further below.

Client computer systems 730, 740, 750, and 760 can each, with the appropriate web browsing software, view HTML pages provided by the web server 720. The ISP 710 provides Internet connectivity to the client computer system 730 through the modem interface 735 which can be considered part of the client computer system 730. The client computer system can be a personal computer system, a network computer, a Web TV system, or other such computer system.

Similarly, the ISP 715 provides Internet connectivity for client systems 740, 750, and 760, although as shown in FIG. 7, the connections are not the same for these three computer systems. Client computer system 740 is coupled through a modem interface 745 while client computer systems 750 and 760 are part of a LAN. While FIG. 7 shows the interfaces 735 and 745 as generically as a “modem,” each of these interfaces can be an analog modem, ISDN modem, cable modem, satellite transmission interface (e.g. “Direct PC”), or other interfaces for coupling a computer system to other computer systems.

Client computer systems 750 and 760 are coupled to a LAN 770 through network interfaces 755 and 765, which can be Ethernet network or other network interfaces. The LAN 770 is also coupled to a gateway computer system 775 that can provide firewall and other Internet related services for the local area network. This gateway computer system 775 is coupled to the ISP 715 to provide Internet connectivity to the client computer systems 750 and 760. The gateway computer system 775 can be a conventional server computer system. Also, the web server system 720 can be a conventional server computer system.

Alternatively, a server computer system 780 can be directly coupled to the LAN 770 through a network interface 785 to provide files 790 and other services to the clients 750, 760, without the need to connect to the Internet through the gateway system 775.

FIG. 8 is a block diagram of an embodiment of a computer that can be used as a client computer system or a server computer system or as a web server system. Such a computer system can be used to perform many of the functions of an Internet service provider, such as ISP 710. The computer system 800 interfaces to external systems through the modem or network interface 820. It will be appreciated that the modem or network interface 820 can be considered to be part of the computer system 800. This interface 820 can be an analog modem, ISDN modem, cable modem, token ring interface, satellite transmission interface (e.g. “Direct PC”), or other interfaces for coupling a computer system to other computer systems.

The computer system 800 includes a processor 810, which can be a conventional microprocessor such as an Intel Pentium microprocessor or Motorola Power PC microprocessor. Memory 840 is coupled to the processor 810 by a bus 870. Memory 840 can be dynamic random access memory (DRAM) and can also include static RAM (SRAM). The bus 870 couples the processor 810 to the memory 840, also to non-volatile storage 850, to display controller 830, and to the input/output (I/O) controller 860.

The display controller 830 controls in the conventional manner a display on a display device 835 which can be a cathode ray tube (CRT) or liquid crystal display (LCD). The input/output devices 855 can include a keyboard, disk drives, printers, a scanner, and other input and output devices, including a mouse or other pointing device. The display controller 830 and the I/O controller 860 can be implemented with conventional well-known technology. A digital image input device 865 can be a digital camera which is coupled to an I/O controller 860 in order to allow images from the digital camera to be input into the computer system 800.

The non-volatile storage 850 is often a magnetic hard disk, an optical disk, or another form of storage for large amounts of data. Some of this data is often written, by a direct memory access process, into memory 840 during execution of software in the computer system 800. One of skill in the art will immediately recognize that the terms “machine-readable medium” or “computer-readable medium” includes any type of storage device that is accessible by the processor 810 and also encompasses a carrier wave that encodes a data signal.

The computer system 800 is one example of many possible computer systems which have different architectures. For example, personal computers based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 840 for execution by the processor 810. A Web TV system, which is known in the art, is also considered to be a computer system according to this embodiment, but it may lack some of the features shown in FIG. 8, such as certain input or output devices. A typical computer system will usually include at least a processor, memory, and a bus coupling the memory to the processor.

In addition, the computer system 800 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. Another example of an operating system software with its associated file management system software is the LINUX operating system and its associated file management system. The file management system is typically stored in the non-volatile storage 850 and causes the processor 810 to execute the various acts required by the operating system to input and output data and to store data in memory, including storing files on the non-volatile storage 850.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Some embodiments also relate to apparatus for performing the operations herein. This apparatus may be specially constructed for the required purposes, or it may comprise a general-purpose computer selectively activated or reconfigured by a computer program stored in the computer. Such a computer program may be stored (embodied) in a computer (machine) readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

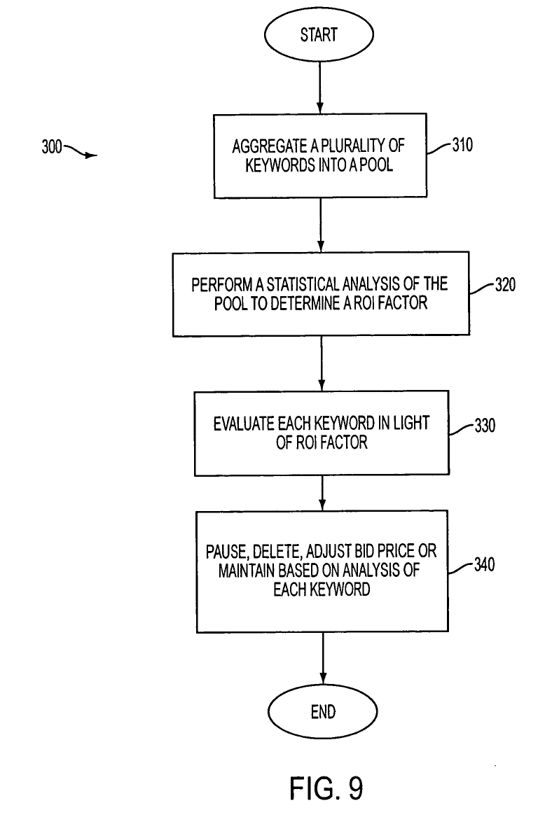

FIG. 9 is a flowchart illustrating a method for adjusting a keyword bid, in accordance with an embodiment of the present invention. After a start operation, a plurality of similar keywords are aggregated into a pool at an operation 310 and statistical analysis is performed to determine a return on investment (ROI), at an operation 320. Pooling may be performed by pattern recognition, clustering or other suitable methods. Each keyword is then evaluated in light of the ROI factor at operation 330. Finally, at an operation 340, a keyword may be temporarily retired/paused, deleted or its bid price will be maintained or modified based on the analysis of each keyword.

This invention potentially allows for automatic, quantitative analysis of the performance of keywords. By optimizing a price of a keyword, profitability can perhaps be maximized.

While this invention has been described in terms of certain embodiments, it will be appreciated by those skilled in the art that certain modifications, permutations and equivalents thereof are within the inventive scope of the present invention. It is therefore intended that the following appended claims include all such modifications, permutations and equivalents as fall within the true spirit and scope of the present invention

What is claimed is:

1. A computer-implemented method for adjusting keyword bids comprising:
aggregating a plurality of keywords into a pool;
performing a statistical analysis of the pool to determine an economic factor;
evaluating each keyword in view of the economic factor; and
pausing use of an individual keyword, maintaining or adjusting a bid price of the individual keyword or deleting the individual keyword based on the economic factor.

2. The computer-implemented method as recited in claim 1 wherein aggregating the plurality of keywords into the pool is accomplished by a pattern recognition technique.

3. The computer-implemented method as recited in claim 1 wherein aggregating the plurality of keywords into the pool is accomplished by a clustering technique.

4. The computer-implemented method as recited in claim 1 wherein use of the individual keyword is paused if the determined economic factor indicates that the keyword is not profitable.

5. The computer-implemented method as recited in claim 4 wherein the individual keyword is returned to use due to a delayed indication of profitability.

6. The computer-implemented method as recited in claim 1 wherein the individual keyword is deleted if the determined economic factor indicates that the keyword is not profitable.

7. The computer-implemented method as recited in claim 1 wherein the bidprice of the individual keyword is further increased if a previous increase of the bidprice resulted in an increased profit as measured by the economic factor.

8. The computer-implemented method as recited in claim 1 wherein the bidprice of the individual keyword is increased if a previous decrease of the bidprice of the individual keyword resulted in a decreased profit as measured by the economic factor.

9. The computer-implemented method as recited in claim 8 wherein the increased bidprice of the individual keyword is increased beyond an original bidprice.

10. The computer-implemented method as recited in claim 1 wherein the bidprice of the individual keyword is decreased if a previous increase of the individual keyword resulted in a decreased profit as measured by the economic factor.

11. The computer-implemented method as recited in claim 10 wherein the decreased bidprice of the individual keyword is decreased beyond an original bidprice.

12. The computer-implemented method as recited in claim 1 wherein the bidprice of the individual keyword is further decreased if a previous decrease of the individual keyword resulted in an increased profit as measured by the economic factor.

13. A computer-implemented-method for adjusting keyword bids comprising:
aggregating a plurality of keywords into a pool;
performing a least-squares regression and a confidence interval on the pool to determine a return-on-investment factor;
evaluating each keyword in view of the return-on-investment factor; and
pausing use of an individual keyword, maintaining or adjusting a bid price of the individual keyword or deleting the individual keyword based on the return-on-investment factor.

14. The computer-implemented method as recited in claim 13 wherein the confidence interval is calculated at a 95% certainty.

15. The computer-implemented method as recited in claim 13 wherein aggregating the plurality of keywords into the pool is accomplished by a pattern recognition technique.

16. The computer-implemented method as recited in claim 13 wherein aggregating the plurality of keywords into the pool is accomplished by a clustering technique.

17. The computer-implemented method as recited in claim 13 wherein use of the individual keyword is paused if the return-on-investment factor indicates that the keyword is not profitable.

18. The computer-implemented method as recited in claim 17 wherein the individual keyword is returned to use due to a delayed indication of profitability.

19. The computer-implemented method as recited in claim 13 wherein the individual keyword is deleted if the return-on-investment factor indicates that the keyword is not profitable as measured by the economic factor.

20. A system for adjusting keyword bids comprising:
one or more report parsers for extracting one or more keyword statistical reports;
a database for storing the one or more keyword statistical reports;
a bid engine for analyzing the one or more keyword statistical reports and adjusting the keyword bid.

21. The system as recited in claim 20 wherein the bid engine increases the keyword bid of a profitable keyword.

22. The system as recited in claim 20 wherein the bid engine decreases the keyword bid of a non-profitable keyword.

23. The system as recited in claim 22 wherein the bid engine temporarily suspends use of the non-profitable keyword if the non-profitable word does not later become profitable.

24. The system as recited in claim 24 wherein the bid engine returns the non-profitable keyword to use due to a delayed indication of profitability.

25. A computer-implemented method for enhancing profitability of a keyword bid comprising:
determining if a volume of the keyword is below about a first threshold;
determining if the keyword bid is below about a second threshold; and
adjusting the keyword bid based on the profitability of the keyword bid, the volume of the keyword in relation to the first threshold and the keyword bid in relation to the second threshold.

26. The computer-implemented method as recited in claim 25 wherein the keyword bid is adjusted upward if the keyword bid is profitable, the volume of the keyword is below about the first threshold and the keyword bid is below about the second threshold.

27. The computer-implemented method as recited in claim 25 wherein the keyword bid is adjusted upward by a percentage if the keyword bid is profitable, the volume of the keyword is below about the first threshold and the keyword bid is not below about the second threshold.

28. The computer-implemented method as recited in claim 27 wherein the percentage is about 50%.

29. The computer-implemented method as recited in claim 25 wherein the keyword bid is adjusted upward if the keyword bid is profitable, the volume of the keyword is not below about the first threshold and the keyword bid is below about the second threshold.

30. The computer-implemented method as recited in claim 25 wherein the keyword bid is adjusted upward by a percentage if the keyword bid is profitable, the volume of the keyword is not below about the first threshold and the keyword bid is not below about the second threshold.

31. The computer-implemented method as recited in claim 30 wherein the percentage is about 10%.

32. The computer-implemented method as recited in claim 25 wherein the keyword bid is adjusted upward or downward if the keyword bid is not profitable, the volume of the keyword is below about the first threshold and the keyword bid is below about the second threshold.

33. The computer-implemented method as recited in claim 25 wherein the keyword bid is changed to a previously profitable keyword bid if the keyword bid is not profitable, the volume of the keyword is below about the first threshold and the keyword bid is not below about the second threshold.

34. The computer-implemented method as recited in claim 33 wherein a related keyword of the keyword bid is retired if the previously profitable keyword bid does not exist.

35. The computer-implemented method as recited in claim 25 wherein the keyword bid is adjusted downward by a percentage if the keyword bid is not profitable, the volume of the keyword is not below about the first threshold and the keyword bid is not below about the second threshold.

36. The computer-implemented method as recited in claim 35 wherein the percentage is about 50%.
